(19) United States
(12) Patent Application Publication
(10) Pub. No.: US 2012/0196112 A1
(43) Pub. Date: Aug. 2, 2012

(54) Electrical insulation incorporating a biaxially oriented polyester film with a high portion of cyclohexanedimethanol and a primary and secondary dicarboxylic acid portion

(76) Inventors: Holger KLIESCH, Ginsheim-Gustavsburg (DE); Oliver Klein, Ockenheim (DE); Dagmar Klein, Ockenheim (DE); Ingo Fischer, Heistenbach (DE); Andreas Bork, Wiesbaden (DE)

(21) Appl. No.: 13/355,934

(22) Filed: Jan. 23, 2012

(30) Foreign Application Priority Data
Jan. 31, 2011 (DE) 10 2011 009 821.6

(51) Int. Cl. H01B 3/42; C08G 63/199

(52) U.S. Cl. 428/220; 528/305; 524/604; 524/605

(57) ABSTRACT

The invention relates to electrical insulation films incorporating biaxially oriented film predominantly formed from polyester. The polyester has a diol component that includes at least 80 mol-% of 1,4-cyclohexanedimethanol (CHDM) and a dicarboxylic acid component containing at least 80 mol-% of one or more benzenedicarboxylic acid(s) and/or one or more naphthalene dicarboxylic acid(s). The dicarboxylic acid component includes a main dicarboxylic acid component forming an at least 55 mol-% portion, chosen from either 2,6-naphthalene dicarboxylic acid or terephthalic acid. The dicarboxylic acid component further includes a secondary dicarboxylic acid component, present in an amount of at least 5 mol-%, with the secondary dicarboxylic acid component differing from the main dicarboxylic acid component. The invention further relates to a method for producing the film and its use.

### CROSS-REFERENCE TO RELATED APPLICATIONS

This application claims priority to German Patent Application 10 2011 009 821.6 filed Jan. 31, 2011 which is hereby incorporated herein by reference in its entirety.

### FIELD OF THE INVENTION

The invention relates to electrical insulation incorporating biaxially oriented film made of polyester, particularly backside insulation of solar modules incorporating polyester film. These films are characterized by their good manufacturability, a very good hydrolysis ability and good electrical insulating properties.

### BACKGROUND OF THE INVENTION

Biaxially oriented films made of polyesters are generally known.

In electrical insulation applications, like cables, motor insulation or applications for backside laminates of solar modules, relatively long durabilities of several years, partially under application temperatures, which reach the region of the glass temperature of polyethylene terephthalate (=PET), the polyester mainly used in the industrial practice, of about 78° C., are normally demanded. Under these conditions, the hydrolysis tendency of the polyesters becomes critical for the durability in the application. Though influencing variables such as a low carboxyl endgroup content (CEG content) on the hydrolysis rate have been known for a very long time (for example U.S. Pat. No. 3,051,212), the methods applied in the industrial practice for producing polyesters with a low carboxyl endgroup content require meticulous process control and subsequent solid state polymerization.

A disadvantage of such raw materials is particularly apparent if the production waste (also called recycled material or reclaim) of the film production is reintroduced in an amount as high as possible into this same film production; as is necessary due to economic reasons during the commercial production of polyester films. During the production of biaxially oriented polyester films, typically 1.5 to 2.5 kg of raw material is needed for one kg of film as required by the process. The remaining amount (0.5 to 1.5 kg/kg of film) is generated in the form of edge trims and film scrap, which is ground and subsequently directly reintroduced, or is extruded and regranulated and is then reintroduced (recycled material, reclaim). But during film production and all the more during later repeated extrusion for the production of reclaim, the carboxyl endgroup content strongly increases and thus limits the reintroduction of reclaim, or even leads to not using it at all. But the reduction of the hydrolysis rate, for example by adjusting with a low carboxyl endgroup content of the polyester, is limited in its impact, and without further complex additive systems, the resulting films are still not sufficiently hydrolysis stabilized for many applications, like backside laminates in solar modules.

By choosing different monomers than ethylene glycol and terephthalic acid the hydrolysis rate of PET can also be significantly reduced. From polyethylene naphthalate (PEN) with naphthalene dicarboxylic acid as monomer instead of terephthalic acid, films with a significantly reduced hydrolysis rate can be received, but they are limited in their applicability by the high raw material price (approx. factor 5 compared to PET) as well as by the significantly more difficult production of biaxially oriented films (amongst others caused by the strongly increased glass temperature of approx. 120 to 125° C.). Furthermore, for example for the backside laminate of a solar module, a contact to other films from different polymers (polyester, EVA, et al.) must be made. The relatively inert nature of PEN makes the production of such laminates more complicated than when using other polyesters.

PCT=poly(1,4-cyclohexane-dimethylene)-terephthalate is also known as hydrolytically stable polyester, but is not used commercially in biaxially oriented films. The reason is the brittleness of the material, particularly after heat setting the biaxially oriented films, which is necessary for reduction in shrinkage. Thus, PCT mostly enters the market as PETG (=PET with cyclohexanedimethanol [CHDM]+ethylene-glycol [EG] as diol monomer units, mostly with more than 50 mol-% EG). But PETG is no longer hydrolytically stable, so that it is no longer suitable for the envisaged use (electrical insulation particularly in solar modules).

In backside laminates for solar modules, at least the outermost laminate layer, ideally the whole laminate, should have a hydrolytic stability so high that even after 25 years of outdoor use, sufficient insulation is assured. Today, this is usually solved by laminates made of polyvinyl fluoride (PVF) (for example Tedlar®, DuPont) and PET, wherein at least the outer side of the laminate includes or consists of Tedlar® and typically, the PET lies between two layers of Tedlar® as an insulating middle layer. But Tedlar® and other fluoropolymers are expensive and will also become a major recycling problem in the future, when the number of solar modules which will have reached the end of their life cycle strongly increases, since they can neither simply be regenerated, nor can they be disposed (for example burned) in compliance with a green environment.

### SUMMARY OF ADVANTAGEOUS EMBODIMENTS OF THE INVENTION

It was the purpose of the present invention to find a polyester film in the thickness of 12-600 μm, which does not have the mentioned disadvantages in the state of the art, which can be manufactured cost-effectively and which is characterized by good electrical insulation properties, particularly when incorporated into the backside laminate of solar modules, and which is therefore suitable for incorporation into electrical insulation applications.

The present invention thus relates to electrical insulation incorporating a biaxially oriented film made of a polyester, the thickness of which preferably lies within the range of 12 to 600 μm, and particularly relates to backside insulation of solar modules incorporating the inventive film. The film predominantly includes or consists of a polyester, the diol component of which substantially includes or consists of cyclohexanedimethanol. The dicarboxylic acid component of the polyester for a significant (=main) portion includes or consists of a benzenedicarboxylic acid or naphthalene dicarboxylic acid, wherein at least 5 mol-% of the dicarboxylic acid component includes of consists of a different dicarboxylic acid than the mainly used benzenedicarboxylic acid or naphthalene dicarboxylic acid. These films are characterized by their good manufacturability, very good hydrolysis stability and good electrical insulating properties.

### BRIEF DESCRIPTION OF THE DRAWINGS

FIG. 1 is a cross-sectional schematic illustration of an exemplary laminate incorporating an exemplary inventive film;

FIG. 2 is a cross-sectional schematic illustration of an alternative exemplary laminate incorporating a different exemplary inventive film;

FIG. 3 is a cross-sectional schematic illustration an exemplary backside insulation of a solar cell incorporating an exemplary inventive film;

FIG. 4 is a cross-sectional schematic illustration of the layer structure of an exemplary multi-layered inventive film; and

FIG. 5 is a cross-sectional schematic illustration of a further exemplary laminate incorporating an exemplary inventive film.

### DETAILED DESCRIPTION OF ADVANTAGEOUS EMBODIMENTS OF THE INVENTION

The inventive electrical insulation incorporates a biaxially stretched (═Oriented) film, which predominantly includes or consists of a polyester, the diol component of which includes or consists of at least 80 mol-%, preferably of at least 95 mol-% and particularly preferably of at least 99 mol-% of 1,4-cyclohexanedimethanol (CHDM). CHDM can be present as cis-isomer c-CHDM, trans-isomer t-CHDM or as a mixture c/t-CHDM. According to the invention, a “diol component” is the structure, which is part of the polyester backbone, which is derived from a diol; the derived structure takes its name from the monomeric compound, wherein the name of the monomeric compound as such is, where appropriate, also used herein alternatively and equivalently instead of the component. The higher the cyclohexanedimethanol portion, the higher the hydrolysis resistance as well. The dicarboxylic acid component of the polyester includes or consists of at least 80 mol-% of a benzenedicarboxylic acid and/or a naphthalene dicarboxylic acid (=NDC), preferably of at least 95 mol-% and particularly preferably of at least 99 mol-% of a benzenedicarboxylic acid and/or a naphthalene dicarboxylic acid. According to the invention, a “dicarboxylic acid component” is the structure, which is part the polyester backbone, which is derived from a dicarboxylic acid; the derived structure takes its name from the monomeric compound, wherein the name of the monomeric compound as such is, where appropriate, also used herein alternatively and equivalently instead of the component. Preferably, the dicarboxylic acid component in the amounts mentioned above includes or consists of a benzenedicarboxylic acid. The preferred naphthalene dicarboxylic acid is 2,6-naphthalene dicarboxylic acid (2,6-NDC) and the preferred benzenedicarboxylic acid is terephthalic acid (=TA).

In a particularly preferred embodiment with good hydrolytic stability, the dicarboxylic acid component includes or consists of at least 55 mol-% (=mainly used dicarboxylic acid component), preferably of at least 60 and particularly preferably of 64 mol-% of one of the two preferred dicarboxylic acids and particularly preferred of terephthalic acid.

Besides the mainly used dicarboxylic acid 55 mol-%) at least 5 mol-% of at least one dicarboxylic acid different from the mainly used dicarboxylic acid, i.e. a secondary dicarboxylic acid component, is always present. This may, for example, be 2,6-naphthalene dicarboxylic acid when the main component is terephthalic acid, and vice versa. In a particularly preferred embodiment with good hydrolytic stability and good manufacturability (low brittleness), the polyester contains at least 5.0 mol-% isophthalic acid (IPA) and preferably at least 10 mol-% isophthalic acid and particularly preferably at least 25 mol-% isophthalic acid as further dicarboxylic acid component (mol-% based on the totality of the dicarboxylic acid components). The higher the isophthalic acid portion, the better the film can be produced economically, because the number of breaks decreases and the edge brittleness reduces. Below 18.0 mol-% IPA, the productivity was unsatisfying due to the factors mentioned above, however, the films were still suitable for the purpose of the invention—if they could be produced. Above 25 mol-%, a productivity comparable to standard-PET could be achieved. The portion of isophthalic acid should not be above 40 mol-% and better not be above 36 mol-%, because then, the thermal and hydrolytic stability of the films remarkably reduces. Above 40 mol-% IPA, the raw materials tend to be sticky in the feeding zones of the extruders and gel formation remarkably increases in the extrusion.

The ranges indicated for IPA apply in the same way also for other dicarboxylic acids like NDC, preferably 2,6-NDC, as second component at TA as main dicarboxylic acid or TA as second component at NDC, preferably 2,6-NDC, as main dicarboxylic acid. This also applies for 1,4-cyclohexane dicarboxylic acid and others, wherein TA, NDC, preferably 2,6-NDC, and IPA are the preferred dicarboxylic acids.

Other dicarboxylic acids than the above terephthalic acid, isophthalic acid or NDC, respectively 2,6-NDC, such as further aromatic, but also aliphatic dicarboxylic acids may also be contained, but generally lead to a deterioration of the production properties and/or the thermal and hydrolytic stability. Therefore, their portion—if present at all—is preferably below 10 mol-% and ideally below 1 mol-%.

As described above, TA is the most preferred dicarboxylic acid. In a preferred embodiment, at least 5 mol-%, preferably at least 10 mol-% NDC, preferably 2,6-NDC, are present besides TA, wherein more than 25 mol-% are less preferred and ideally, 21 mol-% NDC, respectively 2,6-NDC, should not be exceeded. Besides TA and NDC, preferably 2,6-NDC, in a particularly preferred embodiment, IPA is also present in the amounts mentioned above. The higher the portion of NDC, respectively 2,6-NDC, the higher the mechanical strength of the resulting films. An increasing NDC/2,6-NDC-content furthermore positively affects the hydrolysis resistance. But with an increasing NDC/2,6-NDC-content, the raw material costs rise and the manufacturability is more difficult.

The above polyesters can—if they are not commercially available—for example be produced according to the in principle known DMT-method or according to the TPA-method, as it is clarified below in the description of the production of the masterbatches. Thereby, the corresponding diols and dicarboxylic acids (TPA-method), respectively their lower alkyl esters (DMT-method) are reacted in the said molar amounts.

The film contains a polyester as main component. The film preferably includes or consists of at least 70% by weight, and particularly preferably of 95% by weight of a polyester, wherein inorganic fillers are neglected. The remaining no more than 30% by weight may be other polymers, like polypropylene or other organic fillers, like UV stabilizers or flame retardants (the % by weight are based on the mass of the total film, wherein inorganic fillers are neglected).

The above polyesters may contain further monomers besides the main monomers mentioned above. Further diols are for example ethylene glycol (EG), propylene glycol (PG), 1,4-butanediol, diethylene glycol (DEG), neopentyl glycol and others. The portion of diols other than CHDM is less than or equals 20 mol-%, preferably less than or equals 5 mol-% and ideally less than or equals 1 mol-%. The higher the cyclohexanedimethanol portion, the higher also the hydrolysis resistance.

The film according to the invention may furthermore contain inorganic or organic particles, which are required for adjusting the surface topography, optics (gloss, haze, etc.), or improve the operational stability and windability. Such particles are for example calcium carbonate, apatite, silica, titanium dioxide, aluminum oxide, cross-linked polystyrene, cross-linked polymethyl methacrylate (PMMA), zeolites and other silicates like aluminum silicates. These compounds are usually introduced in amounts from 0.05 to 5% by weight, preferably 0.1 to 0.6% by weight (based on the weight of the film). Particularly preferred is calcium carbonate and especially silica.

The introduced particle sizes d₅₀ are generally between 0.1 and 8 μm and preferably between 0.3 and 5.5 μm and particularly preferably between 0.5 and 2.5 μm, in order to achieve a good operational stability in the production. Fibrous inorganic additives like fiber glass are not suitable, since they make the production of the polyester film uneconomical, because they have many breaks. The lower the d₅₀-value of the introduced particles (this also applies to the white pigments described below), the higher the partial discharge resistance (see below). If particles with a d₅₀ of above 8 μm are introduced, the preferred partial discharge resistances can no longer assuredly be achieved.

In an embodiment according to the invention, the film which is to be used is white.

The white pigments may be identical with the above mentioned particles for improving the windability, but then have to be added in a sufficient amount and particle size, in order to achieve whitening. As white pigment, titanium dioxide, barium sulfate, zinc oxide, calcium carbonate or incompatible polymers like polypropylene, polyethylene or cycloolefine copolymers (COCs) or combinations of these are particularly suitable. These are added to the polyester at 1-30% by weight, wherein the preferred adding amount is between 2 and 20% by weight (based on the total weight of the film). Particularly preferred, in this embodiment, the film contains between 3 and 10% by weight (based on the total weight of the film) of white pigment. More white pigment/incompatible polymer leads to a better light reflection and to an improved UV protection, but also leads to higher costs due to the white pigment/polymers and reduces the breaking resistance from about 10% by weight portion on, and from 20% by weight on, it leads to a hindered manufacturability of the film due to increasing breaks. From 10 and particularly from 30% by weight on, the electrical properties of the film also degrade.

The particle sizes (d₅₀) of the introduced inorganic white pigments are generally between 0.05 and 5 μm and preferably between 0.07 and 3.5 μm and ideally between 0.1 and 2.5 μm, in order to achieve a good operational stability and a good degree of whiteness (only applies for inorganic white pigments; organic pigments usually fuse). The preferred white pigments are barium sulfate and titanium dioxide, wherein titanium dioxide is particularly preferred. Surprisingly, using titanium dioxide leads to a better dielectric strength and to a higher partial discharge resistance than when using barium sulfate or zinc oxide. Calcium carbonate alone only leads to sufficient whitening when the concentration is very high, and should therefore be combined with another white pigment. When using barium sulfate, usually more than 10% by weight have to be used in order to achieve good degrees of whiteness and UV stabilities. This leads to the disadvantages described above. The addition of TiO₂ is furthermore particularly preferred when the TiO₂ is inorganically coated and, where appropriate, additionally organically coated. The preferred inorganic coatings, respectively additives for TiO₂ are thereby SiO₂, preferably Al₂O₃ and particularly preferred combinations of SiO₂ and Al₂O₃. The portion of SiO₂ and Al₂O₃ is preferably at >1% by weight (based on the TiO₂), particularly preferably at >3% by weight and ideally at >5% by weight. The high portions of inorganic coating components are particularly favorable for the UV stability of the films according to the invention, because a polymer with a high portion of cyclohexanedimethanol monomer is—contrary to PET—significantly more sensitive towards attack by oxygen and radicals. Under UV irradiation, this can be strongly accelerated by the TiO₂ and should, if UV exposure occurs in the end use, be reduced by suitably choosing coated TiO₂-types. The inorganic coating reduces the catalytically effective surface of the TiO₂, which may lead to yellowing and embrittlement of the film, while the organic coating positively affects the introduction of the TiO₂ into the thermoplastic polyester. Suitable TiO₂-types are commercially available. By way of example, R-105 by DuPont (USA) and RODI® by Sachtleben (Germany) be mentioned. The addition of the TiO₂ on the one hand causes the whitening of the film (as does the use of other white pigments) and due to the increased light reflection leads to an increase in electrical yield when using the film in backsheets of solar modules. On the other hand, it improves the UV resistance of the film, respectively of the backsheet (by back reflecting the UV light), which is particularly advantageous when the solar module is used outdoors. The average particle diameter (d₅₀) of the TiO₂ is preferably in the range of 0.1 to 0.5 μm, particularly preferably 0.15 to 0.3 μm. The added amount of TiO₂ is preferably 2 to 25% by weight, especially preferably 3 to 12% by weight, particularly preferably 4 to 8% by weight (based on the total weight of the film). The best light reflection and the best UV protection are achieved, when TiO₂ is used in the rutile modification.

Besides the mentioned additives, the film may additionally contain further components, such as flame retardants (preferably organic phosphoric acid esters) and/or UV stabilizers and thermal stabilizers. A selection of suitable UV stabilizers can be found in FR 2812299, whose United States equivalents are United States Patent Application Publication Nos. 2002/083641A1; 2010/178484A1; 2009/291289A1; and 2009/042006. Particularly preferred are UV stabilizers, which act as UV absorbers, especially on a triazine base, since these in particular have a sufficient long-term stability (typically, more than 20 years are required in solar modules), or a product of the HALS-group (hindered amin light stabilizers), which additionally protect the oxidatively sensitive polymers with a high cyclohexanedimethanol portion, typically without considerably absorbing UV light themselves. A combination of triazine and HALS has proven to be particularly favorable, wherein instead of the triazine, an UV absorber from another product group, like benzotriazoles or benzophenones, can also be used. In a preferred embodiment, UV stabilizers are added between 0.1 and 5% by weight (based on the total weight of the layer to which they are added), wherein effective minimum share of UV absorber and HALS is 0.1% by weight each, so that a combination of both products always leads to at least 0.2% by weight in the concerning layer. When under strong UV exposure (direct unprotected exposure to sunlight or indirect exposure to sunlight for several years), the portion of UV absorber+HALS should be at least 1% by weight in the layer which is exposed the strongest.

Especially in white embodiments, an addition of stabilizer to a layer underneath the layer, which faces the source of light, does not lead to a significant improvement of the UV stability. Therefore, in the case of such multilayer films and particularly in white embodiments, an addition is carried out particularly in the covering layer(s); the layer(s) underneath the covering layer(s) does/do not contain any UV stabilizer at all, or only by means of the introduction of reclaim, thus preferably less than 60% and particularly preferably less than 30% of the percent-by-weight portion of the stabilizer, which is contained in the covering layer(s). An inventive example of applicable stabilizers from the group of UV absorbers is the commercially available Tinuvin® 1577 (manufacturer BASF, formerly Ciba SC, Switzerland; 2-(4,6-diphenyl-1,3,5-triazine-2-yl)-5-(hexyl)oxyphenol). For the compounds of the HALS-group, especially polymeric, respectively oligomeric stabilizers with a molecular weight >500, particularly preferably >900 and ideally >1300 have proven to be particularly favorable. Examples which may be mentioned here are methylated reaction products of N,N′-bis(2,2,6,6-tetramethyl-4-piperidinyl)-1,6-hexadiaminepolymers with morpholine-2,4,6-trichloro-1,3,5-triazine (CAS NUMBER 193098-40-7), which are commercially distributed as CYASORB®-ZV-3529 by Cytec, USA and which are particularly preferred for the purpose of the invention. At lower concentrations than lower-molecular weight stabilizers, the polymeric and oligomeric HALS lead to an effective stabilization and lead to films with better electrical properties.

When using the above stabilizers in the indicated amounts, the transparency of the films according to the invention in the UV-A range at 370 nm is <20% and preferably is <10% and particularly preferably is smaller than 5%.

Furthermore, it has proven to be favorable to add a stabilizer in form of a radical scavenger to the film, since this can improve the thermal long-term stability. Expediently, the film according to the invention contains such radical scavengers, respectively thermal stabilizers in amounts of 50 to 15000 ppm, preferably 100 to 5000 ppm, particularly preferably 300 to 1000 ppm, based on the weight of the film. The stabilizers, which are typically added to the polyester raw material, are randomly selected from the group of primary stabilizers, like sterically hindered phenols or secondary aromatic amines, or the group of secondary stabilizers, like thioether, phosphites and phosphonites as well as zinc-dibutyl-dithiocarbamate or synergistic blends of primary and secondary stabilizers. Preference is given to the phenolic stabilizers. The phenolic stabilizers particularly include sterically hindered phenols, thiobisphenols, alkylidenebisphenols, alkyl phenols, hydroxybenzyl compounds, acylaminophenols and hydroxyphenylpropionates (corresponding compounds are for example described in “Kunststoffadditive”, second edition, Gachter Müller, publisher: Carl Hanser-Verlag, and in “Plastics Additives Handbook”, fifth edition, Dr. Hans Zweifel, publisher: Carl Hanser-Verlag). The stabilizers with the following CAS numbers are particularly preferred: 6683-19-8, 36443-68-2, 35074-77-2, 65140-91-2, 23128-74-7, 41484-35-9, 2082-79-3 as well as IRGANOX® 1222 by Ciba Specialities, Basel, Switzerland, wherein in particular embodiments the types IRGANOX® 1010, IRGANOX® 1222, IRGANOX® 1330 and IRGANOX® 1425 or mixtures thereof are preferred.

The film according to the invention is generally produced according to in principle known extrusion processes and is single- or multilayered.

The thickness of the film is between 12 and 600 μm and preferably between 25 and 350 μm and particularly preferably between 35 and 300 μm. Below 12 μm, a suitable electrical insulation for the envisaged use, especially solar modules, is not achieved and the production becomes increasingly more difficult. From 300 μm on, the tensile strength significantly decreases and above 600 μm it is too low for the envisaged use.

The white pigment(s) and the other additives are preferably added into the corresponding layer via a masterbatch. For the preparation of the masterbatch, preferably pigment/additive and polyester are mixed in a multi-screw extruder and are extruded through an orifice die and are granulated (=extrusion masterbatch).

But the pigment or additive can also be added directly during the production of the polyester, in order to produce a masterbatch- or batch raw material (=polycondensation masterbatch). In doing so, the pigments/additives are, in case the DMT-method (DMT=dimethylterephthalate as starting monomer) is used, usually added after the transesterification, respectively directly before the polycondensation (for example via the feed line between transesterification- and polycondensation reactor) as dispersion in cyclohexanedimethanol. But the addition can also already be carried out before the transesterification. In case of the TPA-method (TPA=terephthalic acid as starting monomer), the addition is preferably carried out at the beginning of the polycondensation. But a subsequent addition is also possible. For this method, it has proven to be favorable if the dispersion in cyclohexanedimethanol is filtered by a PROGAF® 57 (Hayward/Indiana, USA)-filter prior to the addition.

In terms of the technical properties, for example the formation of agglomerates, the polycondensation masterbatches offer an advantage. For short-term adjustments, small or variable batch sizes, the extrusion masterbatch has advantages in terms of the flexibility compared to polycondensation masterbatches.

Dosing the particles or additives in the extruder directly during the production of the film is also possible. But this often has the disadvantage that the homogeneity is worse compared to the other two methods, and that agglomerates may occur, which may negatively affect the properties of the film.

In the method for producing the films according to the invention, it is expedient to proceed in a way in which the corresponding polymer melts, which may be equipped with pigments/additives where appropriate, are extruded through a flat die, the thereby obtained film is stripped and quenched as extensively amorphous pre-film on one or more roller(s) (cooling roller) for solidification, the film is subsequently reheated and biaxially stretched (oriented) and the biaxially stretched film is heat set. It has proven to be favorable if the temperatures in the entire extrusion do not exceed 295° C. and preferably do not exceed 285° C. and ideally do not exceed 280° C., because otherwise there will be noticeable gel formation in the film. This leads, amongst others, to breaks in the production process and to a deterioration of the electrical properties.

The best properties regarding hydrolytic stability and electrical properties are achieved, when the raw materials are melted and extruded in a twin-screw extruder. When single-screw extruders are used, the raw materials should be dried prior to extrusion. This is expediently carried out at temperatures between 110 and 155° C. over a period of 20 minutes to 1.5 hours. Longer periods and higher temperatures lead to a thermal degradation of the introduced polymers.

The biaxial stretching is usually performed sequentially. Thereby, stretching is preferably performed first in longitudinal direction (that is in machine direction=MD) and subsequently in transverse direction (that is vertical to machine direction, TD). This leads to an orientation of the molecular chains. The stretching in longitudinal direction can be performed using two rollers, which run at different speeds, according to the desired stretch ratio. For stretching in transverse direction, a corresponding tenter is usually used.

The temperature, at which the stretching is carried out, may vary in a relatively wide range and is determined by the desired properties of the film. Usually, the longitudinal as well as the transverse stretching are performed at T_{g}+5° C. to T_{g}+50° C. (T_{g}=glass temperature of the polymer with the highest T_{g} in the used (Co-) polyester). It has proven to be favorable for the productivity, if temperatures between T_{g}+5° C. to T_{g}+20° C. are adjusted. The closer to glass temperature the films are stretched, the lower the edge brittleness, which can be watched in the process, which may lead to breaks. The longitudinal stretch ratio is usually within the range of from 2.0:1 to 6.0:1, preferably 2.7:1 to 4.5:1. The transverse stretch ratio is usually within the range of from 2.0:1 to 5.0:1, preferably 3.1:1 to 4.6:1, and that of a, if necessary, second longitudinal and transverse stretching is at 1.1:1 to 5.0:1.

The longitudinal stretching may, where appropriate, be performed simultaneously with the transverse stretching (simultaneous stretching).

During the subsequent heat setting, the film is kept for about 0.1 to 10 s at a temperature of 170 to 255° C., preferably 210 to 250° C., and ideally at a temperature of 220 to 240° C. The temperatures, which are actually experienced (by the film), are mostly 1 to 3° C. below the air temperatures, which are adjusted in the heat setting frame. The temperature (=air or ambient temperature), which is adjusted in the heat setting process cannot be measured directly on a completed film. But it can be determined using the completed film, when, as described in U.S. Pat. No. 6,737,226, column 6, the actually experienced heat setting temperature is determined and 1 to 3° C. are added to it. The result indicates a spectrum for the setting temperature adjusted in the process.

Subsequent to, respectively beginning in heat setting, the film is, where appropriate, relaxed by 0.5 to 15%, preferably by 2 to 8% in transverse and, where appropriate, also in longitudinal direction, and is then cooled and taken up on a roll in a customary way.

In order to achieve the desired good electrical insulation properties, it has proven to be favorable if the area stretch ratio (MD times TD) is greater than 5, respectively better greater than 7 and particularly preferred greater than 8. In a preferred embodiment, the area stretch ratio is below 17. An area stretch ratio above 20 has proven to be unfavorable regarding the operational stability of the film, and from an area stretch ratio of 24 on, it becomes difficult to achieve economically interesting running lengths of the sheet film web.

The mentioned area stretch ratios lead to films, which preferably have a modulus of elasticity of greater 1500 N/mm² in every direction of the film, and particularly preferably of greater 2000 N/mm² in every direction of the film, and ideally of greater 2300 N/mm² in every direction of the film, and have a modulus of elasticity of greater 5000 N/mm² in preferably no direction of the film and ideally have a modulus of elasticity of greater 4000 N/mm² in no direction of the film.

The F5-value (tension at 5% elongation) is preferably at greater 40 N/mm² in every direction of the film and particularly preferably at greater 50 N/mm² in every direction of the film and ideally at greater 60 N/mm² in every direction of the film; preferably, the film has in no direction of the film a tension at 5% elongation of greater 140 N/mm².

The tear strength is preferably in every direction of the film at greater 65 N/mm² and particularly preferably at greater 75 N/mm² in every direction of the film and ideally at greater 85 N/mm² in every direction of the film, and preferably it is in no direction of the film at greater 290 N/mm² and particularly preferably in no direction of the film at >220 N/mm² and ideally in no direction of the film at >190 N/mm².

Compliance with the mentioned mechanical values is extremely advisable, in order to be able to handle the film well in the downstream manufacturing processes (cutting, coiling, laminating, stacking, etc.). High mechanical strengths prevent strains and creases in follow-up processes. With the said upper limits, the risk of a partial overstretching (overexpansion) of the film in the manufacturing process begins, this leads to a lower tensile strength and severely unsteady properties in the overstretched areas. Besides by the stretch ratios, the mechanical strengths are also significantly affected by the IPA-content. The strengths usually decrease when the IPA-content increases, and above 40 mol-% IPA it is difficult to achieve the preferred values (the stretch ratios must be strongly increased, which results in many breaks in the process). Below 20 mol-% and particularly below 10 mol-% IPA, the risk of a partial overstretching (overexpansion) of the film in the manufacturing process increases, if the desired values are to be achieved.

The mentioned stretch ratios furthermore lead to films, which have a sufficient elongation at break to be flexible enough in the backside insulation of solar modules for the mechanical stresses during the fabrication and the application (for example wind load). The elongation at break should be greater than 20% in every direction of the film and is preferably at greater than 45% in every direction of the film and ideally at greater than 75%. For achieving these elongation at break values, it has proven to be favorable if the area stretch ratio is smaller than 24 and better smaller than 17. If the IPA-content increases, the elongation at break increases.

In a preferred embodiment, the shrinkage of the films according to the invention is less than 3% at 150° C. (15 min) in both directions of the film, particularly preferred less than 2.5% and ideally less than 1.9% in both directions of the film. The shrinkage in transverse direction is preferably at <1.0%, particularly preferably at <0.75% and ideally at <0.1%. The shrinkage is preferably in no direction of the film <−1.0% (equivalent to 1.0% elongation), particularly preferably in no direction of the film <−0.75% and ideally in no direction of the film <−0.5%. This can be achieved by adjusting the (ambient=air) temperature in the heat setting at greater 210° C. and preferably at greater 220° C. and particularly preferably at greater 228° C. Preferably, the relaxation in transverse direction is above 3% and preferably, at least 30% of this relaxation is carried out at temperatures below 200° C. The low shrinkage is particularly important for the use in the backside insulation, respectively in backside laminates of solar modules, because in the lamination process, higher temperatures occur, which lead to greater film losses at higher shrinkage values and may additionally cause waves and creases. If the shrinkage values are high, particularly in transverse direction, the film has to be laminated onto the solar module with extra size. The film then shrinks during lamination and any extra sizes, which may still exist afterwards, have to be cut. A significantly negative shrinkage (elongation) leads to waves and creases on the module and thus, a significant number of finished modules would be sorted out.

The two most important electrical properties of the films according to the invention are the break down voltage (=BDV) and the partial discharge voltage (=PDV). Especially the BDV is of particular importance.

The films according to the invention have a BDV (50 Hz, 21° C., 50 rel. humidity, measured in air) of at least 40 V/μm, preferably of at least 100 V/μm and ideally of at least 190 V/μm.

The partial discharge voltage PDV follows the subsequent equation:

PDV[V]=x[V/μm]·thickness of the film [μm]+y[V]

Films according to the invention preferably have x-values of >0.75[V/μm] and y-values of >100 [V], particularly preferably is x>1 [V/μm] and y>200 [V] and very particularly preferably is x>1.5[V/μm] and y>300 [V].

These electrical properties are achieved, when the diol and dicarboxylic acid components of the polyesters in mol-% are within the range according to the invention. The electrical properties are particularly surely achieved, when the mechanical properties are within the preferred, and even better within the particularly preferred ranges, especially when moduli of elasticity and tear strengths do not exceed the mentioned preferred upper limits. For achieving the desired electrical properties, it has furthermore proven to be favorable, if adjusted heat setting temperatures do not fall below 210° C. and do not exceed 250° C.

The durability of polymeric electrical insulation materials based on polyester is significantly influenced by environmental conditions such as heat and relative humidity. A failure criterion of the polyester after aging under certain humidity and temperature criteria may be, that the used film gradually becomes frail and brittle, and therefore water can intrude, which leads to a negative impact on the electrical properties, or may even compromise the desired electrical insulation effect. In applications, in which the electrical insulation film additionally contributes to the mechanical strength of the total laminate, this quality will also be lost after aging.

With polyesters, the reason for the failure is in many cases the hydrolytic splitting of the polyester chains, wherein, from a particular minimal chain length on, the brittleness of the film is so big, that it no longer resists mechanical strains like elongation or bending.

As a measure for the chain length and thereby also for the hydrolytic degradative behavior, respectively the hydrolytic resistance, the standard viscosity (SV) (which is related to ηᵣₑₗ, see below) depending on the aging time was determined. For this, the film samples are conditioned in an autoclave at 110° C. and 100% rel. humidity, and the SV value is checked regularly.

In a preferred embodiment, the SV value is above 750 before starting measuring, particularly preferred above 800 and ideally above 850. A high chain length at the beginning is advantageous, since, at the same degradation speed of the used polymer, it extends the durability. Chain lengths corresponding to a SV value of <600 are to be avoided, since with them, only very short durabilities can be achieved.

Chain lengths, which are too high, that is above a SV of 1200, are also to be avoided, because this may lead to problems in the extrusion, which may negatively affect the process capability and thereby the economic usability.

As a measure for the degradation speed, the SV value is plotted against the time in the autoclave and the slope of the best-fit line is determined. The autoclaving conditions are clarified in the chapter Measuring methods. Under the conditions described in the chapter Measuring methods, a preferred embodiment has a slope of >−3 SV-E/h (SV-E=SV unit), a particularly preferred one has a slope of >−2 SV-E/h, and ideally the slope is at >−1 SV-E/h. A slope of <−4 SV-E/h is to be avoided in any case, since the degradation of the material properties proceeds too rapidly. A slope of greater than or equal to 0 is also difficult, because then there will be material changes in the end use, which differ very much from the present standard (PET as intermediate layer film) and therefore may lead to difficulties in the laminate stability.

The good low SV-degradation speeds according to the invention are achieved, when the diol and dicarboxylic acid components of the polyesters in mol-% are within the range according to the invention, wherein especially exceeding the said upper limits for IPA and EG is unfavorable. Independently of the aforementioned, the SV-degradation speeds are furthermore positively affected, when the film is produced according to the described process parameters.

Films containing the polymer system according to the invention are outstandingly suitable for electrical insulation applications, especially if they are exposed to extended use (years) and to higher temperatures (>60° C.) and to humidity (more than 10% relative humidity), since they preserve their good electrical properties for a long time, also under humid heat conditions. Such applications are for example ribbon cables in cars, cables in seat heatings, motor insulation and above all the backside insulation in solar modules. Thereby, the film can be used alone and as a laminate with other films, for example EVA- or PE-films.

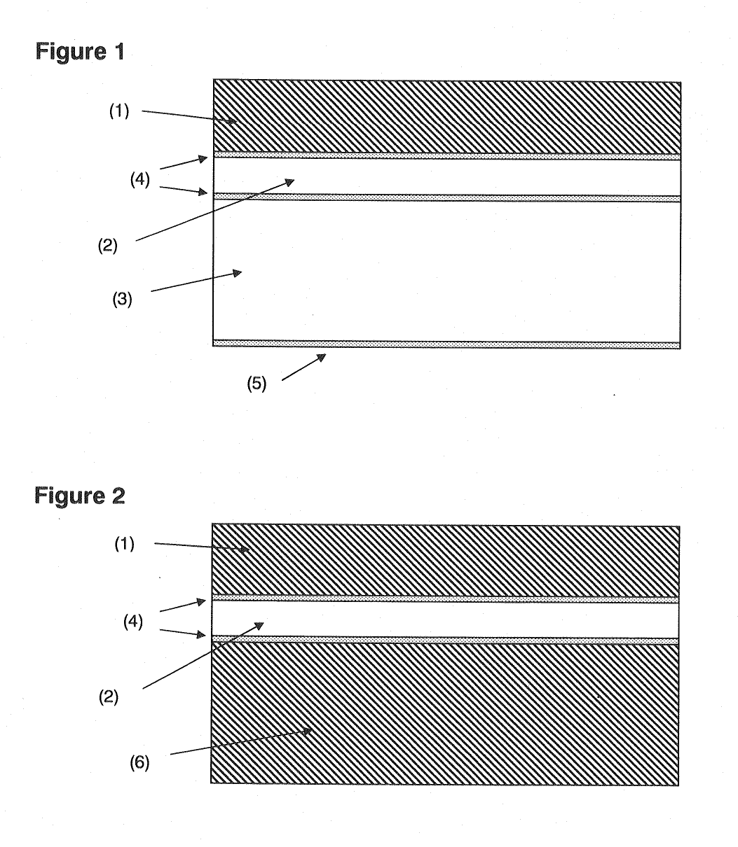

Typical laminates are illustrated in FIGS. 1 to 5.

FIG. 1 shows a laminate with a film used according to the invention (1) with a thickness of 50 μm from example 1, a SiOₓ evaporated polyester film (2) with a thickness of 12 μm, which is available for example as X-BARRIER®-film by Mitsubishi Plastics, and another white polyester film (3) with a thickness of 100 μm, which is for example available as HOSTAPHAN® WDW/WUV- or HOSTAPHAN® WO/UVO-film by Mitsubishi Polyester Film GmbH, Germany. The single films are each held together with a layer of adhesive (4). On the free covering layer of the white film (3), an additional layer of adhesive (5) is applied, in order to provide adhesion to the encapsulation medium (typically EVA) of the solar cell.

FIG. 2 shows the laminate of FIG. 1, but without the adhesive layer (5); furthermore, the white film (3) has been replaced by a white film used according to the invention (6), from example 2.

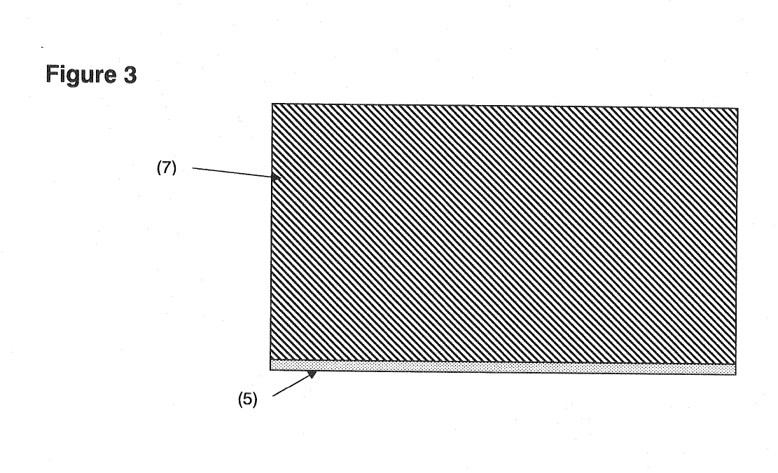

FIG. 3 shows an embodiment, wherein only a film used according to the invention (7) from example 3 with a thickness of 275 μm with an applied layer of adhesive (5) is used as backside insulation of a solar cell.

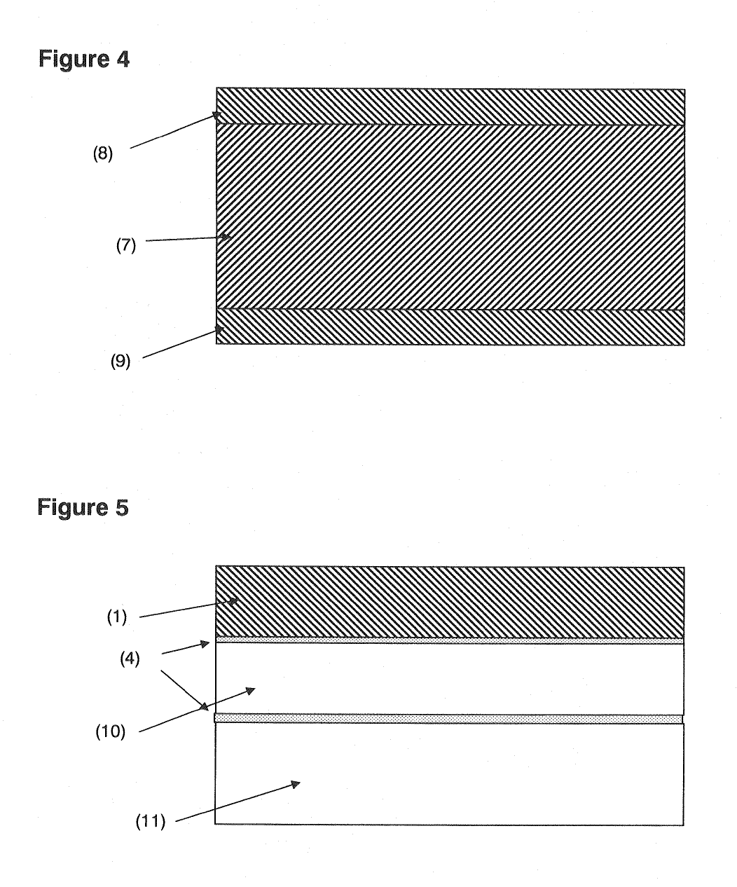

FIG. 4 shows the layer structure of the film used according to the invention of example 4, with the base layer (7), the covering layer (8) and the covering layer (9). The two covering layers (8) and (9) are identical and each have a thickness of 10 μm, and the base layer has a thickness of 255 μm.

FIG. 5 shows a laminate with a film used according to the invention (1) with a thickness of 50 μm from example 1, a polyester film (10) with a thickness of 150 μm, which is available for example as HOSTAPHAN® RN 100-film by Mitsubishi Polyester Film GmbH, Wiesbaden (Germany), and another white polyethylene or polyester film (11) with a thickness of 150 μm. The single films are each held together with a layer of adhesive (4).

The polyester films used according to the invention as well as the other films contained in the laminates are bound using suitable adhesives, which are applied to the film used according to the invention or to the respective other film from solutions and also as hotmelts. The films are then bond to a laminate between two rollers. Suitable adhesives have to be selected according to the respective film type. Adhesives based on polyester, acrylates and other industry standard adhesive systems have proven to be suitable. Preferably, adhesives on polyurethane base are used. Thereby, two-component adhesive systems are particularly preferred.

These consist of polyurethane prepolymers with isocyanate end groups, which can be linked with polyfunctional alcohols. The isocyanate end groups may thereby be either of aromatic nature, like for example diphenylmethanediisocyanate (MDI) or toluenediisocyanate (TDI), or be of aliphatic nature, like for example hexamethylenediisocyanate (HDI) or isophoronediisocyanate (IPDI). The above components are mixed with an excess of isocyanate groups together with further components such as stabilizers, pigments and others, as well as organic solvents, in order to achieve the required properties, like for example adhesiveness, dryness of the adhesive surface, solids content and color matching. The adhesive mixture may cure either at room temperature or at elevated temperature. The surface of the carrier layer and/or the surfaces of the opposite side may be physically pretreated in order to produce an ideal adhesive bond. Suitable methods are the corona pretreatment, as well as a flame treatment and a plasma pretreatment. Preferably, the corona treatment is used, wherein a partial oxidation takes place, which results in an increased polarity of the surface of the material.

The laminate or the single layer of film according to the invention produced in this way then has to be bound with the embedding material of the solar cells during the production of the solar module. The embedding material most commonly used in the industrial practice is ethylene vinyl acetate (EVA); besides that, further materials like polymethyl methacrylate (PMMA), polyvinyl butyral (PVB) and many others can be found.

For bonding with the embedding materials, in principle, the same isocyanate adhesives as used for bonding the laminate layers may be used. If the films according to the invention form the outer layer facing the embedding medium of the cells (as described above, usually EVA), usually an adhesive is not necessary at all, since surprisingly, the films according to the invention already have good adhesive properties towards the common embedding materials (especially towards EVA and PVB). A physical pretreatment as described above additionally improves the adhesion. The adhesion to the embedding media can also be improved by applying a coating. Here in turn, the inline coating technique during the film production process after the longitudinal stretching and prior to transverse stretching has proven to be particularly economical, because no additional process step is necessary.

This coating should have an excellent long-term resistance to moisture and elevated temperature, in order to be suitable for the use as backside cover in solar modules. It should have a good mechanical resistance, in order to safely withstand the stresses and strains which occur during the production of the film, during coiling and uncoiling the film, as well as during the production of the solar modules.

In a preferred embodiment, a coating consisting of a polyurethane and a cross linking agent is applied to the film according to the invention as adhesive agent, as it is for example described in WO 2010/094443.

When polyethylene (PE) or polypropylene films (PP) are used as laminate components, usually adhesive is not necessary. Here, a physical pretreatment as described above is also advantageous.

The film according to the invention, respectively the laminate which contains this film, is applied to the embedding medium during the production of the solar modules, and is compressed with it following known procedures.

In the following exemplary embodiments, measuring the individual properties is carried out in accordance with the given standards, respectively methods.

### Measuring Methods

### Standard Viscosity (SV)

The standard viscosity SV is measured—based on DIN 53726—by measuring the relative viscosity η_{rel.} of a 1% by weight solution in dichloroacetic acid (DOE) in an Ubbelohde viscometer at 25° C. The dimensionless SV value is determined by the relative viscosity η_{rel.} as follows:

SV=(η_{rel.}−1)·1000

For this, film, respectively polymer raw materials are dissolved in DOE and the particles present where appropriate are separated by centrifugation prior to measuring. The portion of particles is determined by ash determination and is corrected by corresponding excess weighed-in quantity. This means weighed-in quantity=(amount of weighed-in quantity according to instruction)/((100-particle content in %)/100)

### Shrinkage

The thermal shrinkage is determined with square film samples with an edge length of 10 cm. The samples are cut so that one edge runs parallel to the machine direction and one edge runs perpendicular to the machine direction. The samples are measured exactly (the edge length L₀ is determined for every machine direction TD and MD, L_{0 TD} and L_{0 MD}) and are tempered in a drying cabinet with recirculating air for 15 min at the indicated shrinkage temperature (here 150° C.). The samples are removed and are measured exactly at room temperature (edge length L_{TD} and L_{MD}). The shrinkage results from the equation

shrinkage[%]MD=100·(L_{0 MD}−L_{MD})/L_{0 MD}

shrinkage[%]TD=100·(L_{0 TD}−L_{TD})/L_{0 TD}

### Measuring the Transparency at 370 nm

Measuring the transparency is carried out with a LAMBDA® 3 UV/V is spectrometer from Perkin Elmer.

### Measuring the Break Down Voltage/Dielectric Strength (BDV)

Measuring the break down voltage is carried out according to DIN 53481-3 (in consideration of DIN 40634 for the special film instructions). The measurement is carried out via ball/plate (electrode diameter 49.5 mm) at a sinusoidal alternating voltage of 50 Hz at 21° C. and 50% rel. humidity, measured in air.

### Measuring the Partial Discharge Voltage (PDV)

The PDV is determined according to IEC 60664-1.

Measuring the Average Particle Diameter d₅₀

The determination of the average particle diameter d₅₀ is carried out using laser on a MASTER SIZER® (Malvern Instruments, UK) according to the standard method (other measuring instruments are e.g. HORIBA® LA 500 (Horiba Ltd., Japan) or HELOS® (Sympatec GmbH, Germany), which use the same measuring principle). For this purpose, the samples are put into a cuvette with water, which is then placed into the measuring instrument. The measuring procedure is automatic and also includes the mathematical determination of the d₅₀-value. The d₅₀-value is thereby determined by definition by the (relative) cumulative curve of the particle size distribution: the intersection of the 50%-ordinate value with the cumulative curve provides the desired d₅₀-value on the x-axis.

### Measuring the Mechanical Properties of the Film

The determination of the mechanical properties is carried out according to DIN EN ISO 527-1 to 3.

### Autoclaving

The films (10·2 cm) are hanged into the autoclave (Adolf Wolf SANOklav type: ST-MCS-204) attached to a wire and the autoclave is filled with 2 l of water. After closing the autoclave, it is heated. At 100° C., the steam displaces the air via the outlet-valve. This is closed after approx. 5 min, whereupon the temperature rises to 110° C. and the pressure rises to 1.2-1.5 bar. After the set time (at least 12 h) the autoclave is automatically turned off and after opening the outlet-valve, the films are removed. Using them, the SV value is determined.

### EXAMPLES

Method: The raw materials were mixed and extruded in a twin-screw extruder by Japan Steel Works with degasification. In the extruder zones and in the melt line the temperature was 275° C. max. The throughput was 2000 kg per hour. The melt was extruded through a flat die (temperature 275° C.) onto a cooling roller (30° C.) and was subsequently stretched at 105° C. by the factor 3.2 in longitudinal direction, and then stretched at 110° C. by the factor 3.2 in transverse direction.

The film was then heat set at 222° C., wherein in the last zone, 2% relaxation in transverse direction were adjusted. In the two following setting zones, 190° C. and 150° C. were adjusted and the relaxation here was another 3%. The total residence time in the heat setting was 15 s.

Raw materials used:
R1=Polycyclohexanedimethanol-terephthalate-isophthalate, type DURASTAR®DS2000 (manufacturer Eastman, USA), SV=980, IPA-content ca. 26 mol-%, TA-content ca. 74 mol-%
R2=Polycyclohexanedimethanol-terephthalate-isophthalate, type EASTAR® A150 (manufacturer Eastman, USA), SV=1100, IPA-content ca. 17 mol-%. TA-content ca. 83 mol-%
R3=raw material R1 with 20% by weight TiO₂ TIPURE® R-105 by DuPont (USA), compounded in a twin-screw extruder by Japan Steel Works with degasification, SV=880
R4=raw material R2 with 20% by weight TiO₂ TIPURE® R-105 by DuPont (USA), compounded in a twin-screw extruder by Japan Steel Works with degasification, SV=980
R5=raw material R1 with 10% by weight TINUVIN® 1577 (manufacturer BASF formerly Ciba SC, Switzerland), compounded in a twin-screw extruder by Japan Steel Works with degasification, SV=870
R6=raw material R1 with 10% CYASORB®-ZV-3529 (manufacturer Cytec, USA), compounded in a twin-screw extruder by Japan Steel Works with degasification, SV=870
R7=PETG type EASTAR® 6763 (manufacturer Eastman, USA), SV=1045, TA-content 100 mol-%, ethylene glycol-content ca. 69 mol-%, cyclohexanedimethanol-content ca. 31 mol-%

The raw material compositions of the individual layers as well as the resulting film properties are shown in Table 1.

TABLE 1

| | | | | | | Comparative |
|---|---|---|---|---|---|---|
| | | example | | | | example |
| property | | 1 | 2 | 3 | 4 | 1 |
| Raw materials | R1 | 75% by weight | 75% by weight | | 100% by weight | |
| (for monolayer in example 1-3 and | R2 | | | 75% by weight | | |
| base layer in case of example 4) | R3 | 25% by weight | 25% by weight | | | |
| | R4 | | | 25% by weight | | |
| | R7 | | | | | 100% by weight |
| Raw materials | R1 | | | | 80% by weight | |
| (Coextrusion layers A/A′ in | R5 | | | | 10% by weight | |
| example 4) | R6 | | | | 10% by weight | |
| Total thickness | in μm | 50 | 100 | 275 | 275 | 50 |
| SV value of the film directly after | — | 896 | 906 | 980 | 911 | 919 |
| production | | | | | | |
| Hydrolysis rate after 144 h in the | in SV/h | −0.70 | −0.74 | −0.83 | −0.84 | −4.1 |
| autoclave | | | | | | |
| shrinkage, longitudinal | in % | 1.5 | 1.7 | 1.7 | 1.8 | |
| shrinkage, transverse | in % | 0.0 | 0.1 | −0.1 | 0.0 | |
| Modulus of elasticity, longitudinal | in N/mm² | 2700 | 2600 | 2800 | 2500 | |
| Modulus of elasticity, transverse | in N/mm² | 2700 | 2600 | 2900 | 2500 | |
| Strength at 5% elongation, | in N/mm² | 77 | 73 | 80 | 70 | |
| longitudinal | | | | | | |
| Strength at 5% elongation, | in N/mm² | 76 | 72 | 78 | 69 | |
| transverse | | | | | | |
| Tear strength, longitudinal | in N/mm | 107 | 110 | 115 | 103 | |
| Tear strength, transverse | in N/mm² | 108 | 109 | 115 | 106 | |
| Elongation at break, longitudinal | in % | 99 | 102 | 70 | 95 | |
| Elongation at break, transverse | in % | 100 | 101 | 73 | 93 | |
| Breakdown voltage/dielectric | in V/μm | 251 | 215 | 195 | 193 | |
| strength (BDV) | | | | | | |
| Partial discharge voltage (PDV) | In V | 376 | 453 | 904 | 1002 | |

That which is claimed:

1. An electrical insulating film comprising a biaxially oriented film predominantly comprised of polyester formed from
(a) a diol component including at least 80 mol-% of 1,4-cyclohexanedimethanol, and
(b) a dicarboxylic acid component including at least 80 mol-% of one or more benzenedicarboxylic acid(s) and/or one or more naphthalene dicarboxylic acid(s), the dicarboxylic acid component including
(i) a main dicarboxylic acid component forming an at least 55 mol-% portion of said dicarboxylic acid component, said main dicarboxylic acid component selected from either 2,6-naphthalene dicarboxylic acid or terephthalic acid, and
(ii) a secondary dicarboxylic acid component forming an at least 5 mol-% portion of said dicarboxylic acid component, wherein the secondary dicarboxylic acid component differs from the main dicarboxylic acid component.

2. A film according to claim 1, wherein the dicarboxylic acid component includes one or more benzenedicarboxylic acid(s).

3. A film according to claim 1, wherein the naphthalene dicarboxylic acid is 2,6-naphthalene dicarboxylic acid and the benzenedicarboxylic acid is terephthalic acid.

4. A film according to claim 1, wherein the main dicarboxylic acid component is terephthalic acid.

5. A film according to claim 1, wherein the secondary dicarboxylic acid component has a portion of at least 10 mol-%.

6. A film according to claim 1, wherein the secondary dicarboxylic acid component is
(a) 2,6-naphthalene dicarboxylic acid when the main dicarboxylic acid component is terephthalic acid, and
(b) terephthalic acid when the main dicarboxylic acid component is 2,6-naphthalene dicarboxylic acid.

7. A film according to claim 1, wherein the secondary dicarboxylic acid component is isophthalic acid.

8. A film according to claim 1, wherein the secondary dicarboxylic acid component has a portion of at least 20 mol %.

9. A film according to one of claim 1, wherein the secondary dicarboxylic acid component has a portion of at least 25 mol %.

10. A film according to claim 1, wherein the film further comprises a white pigment and/or a black pigment.

11. A film according to claim 1, wherein the film comprises inorganic or organic particles that adjust the surface topography, optics or improve the operating reliability and wind-ability of the resulting film.

12. A film according to claim 11, wherein the optics are gloss or haze.

13. A film according to claim 1, wherein the thickness of the film is between 12 and 600 μm.

14. A film according to claim 1, wherein the film is a ribbon cable in a car, a cable in a seat heating or a motor insulation.

15. A film according to claim 1, wherein the film is backside insulation in solar modules.
